(19) United States
(12) Patent Application Publication
(10) Pub. No.: US 2003/0081839 A1
(43) Pub. Date: May 1, 2003

(54) Method for comprising an image in real time

(75) Inventor: Wen-Chao Tseng, Taichung (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: UMAX DATA SYSTEMS INC.

(21) Appl. No.: 09/984,902

(22) Filed: Oct. 31, 2001

(51) Int. Cl. G06K 9/36; G06K 9/46

(52) U.S. Cl. 382/232

(57) ABSTRACT

The present invention relates to a method for compressing an image data in real time. At first, the present invention divides an image, which is got after a pre-scanning process, into plural lines. Each line is divide into several blocks, whose sizes are the same. Each block comprises plural pixel values. A pixel value of a block is saved in the buffer completely to become the first datum. The pixel value is usually the minimum pixel value. Then plural differences, which are between the first datum and the plural pixel values of the block, are calculated. One of the plural differences, which are not equal to zero, is saved in the buffer completely to become the second datum. The difference, which is not equal to zero, is usually a minimum difference. Using the second datum to be a divisor and using the plural differences to be dividends will get plural specific values of plural differences to the second datum. When the first number, which is after a dot, of the specific value is greater than a fixed value or equal to the fixed value, it will be carried to the first number, which is in front of the dot and numbers, which are after the dot, are deleted. When the first number, which is after a dot, of the specific value is lower than a fixed value, numbers, which are after the dot, are deleted. This method will make the specific values become integers. At last, the plural specific values are saved in the buffer completely to become the plural third data and the compression procedure of the block is finished. Then the next block is compressed by the same procedure.

### BACKGROUND OF THE INVENTION

1. Field of the Invention

The present invention relates to a method for compressing an image, more particularly, to a method for compressing an image data in real time to decrease the amount of data and times of data transmission and to improve the velocity of the scanning procedure.

2. Description of the Prior Art

For present information users, especially to the personal computer users, A mode of the computer information has been changed from an unexciting word mode to a multi-media mode. The multi-media mode means that the information comprises words, images, and sounds. In order to show the multi-media mode in the face of viewers, various multi-media devices, which can collect the images and sounds, are developed. Because the multi-media information comprises more matters, memories, which are used to deal with the multi-media information, are greater than memories, which are used to deal with the unexciting word information to show the multi-media information more smoothly.

For an input image device, scanners and digital cameras are the common devices at the present day. The digital camera uses digital information to save the image, which is got from shooting a scene on a location. It uses a floppy disk card or a personal computer memory card international association (PCMCIA) card to save a static image. In order to decrease the memory of saving multi-media information, the images, which is got from shooting a scene on a location by using a digital camera, are saved by using compression files. The file format of a joint photographic experts group (JPEG) mode is common used in the static image compression files.

For using kinds of scanners, the scanners are divided into three kinds, such as: (1) a handly scanner; (2) a desktop scanner (flat bed scanner); and (3) sheet-feed scanner. Dot per inch (DPI) is a unit of a definition of the scanning procedure. If DPI is higher and higher, the quality of the scanner is higher and higher, but time of the scanning procedure is longer and longer. When scanning the color image, most scanners must divide the color image into three primary colors, such as red, green, and blue, to scan. Therefore, the scanning procedure must repeat three times and will cause time of the scanning procedure to be increased.

The desktop scanner is a common scanner, it is used to make the scanned papers, such as perspective papers or reflex papers, to become digital data by passing through a scanning procedure. In general, the photoelectric induction module, which is used in the scanner, comprises a photoelectric induction element. This photoelectric induction element can be a charge-coupled device (CCD) or a contact image sensor (CIS). The desktop scanner is used to make the paper, which is placed on a glass flat top building, transform to digital data by passing through a scanning procedure. The digital data will be transmitted to the personal computer and will be further used on the following steps.

In the scanning procedure, the waited scanning image will mirror or transmit the light, which comes from the source light. The reflex light and the transmission light will be received by using the photoelectric module. The photoelectric module is connected with a controlled circuit and the controlled circuit is connected with the server, such as: personal computer. The reflex light and the transmission light will be transmitted from the photoelectric module to the server to be dealt with.

Using three primary colored lights with different ratio will get each colored light. The three primary colored lights are red light (R), green light (G), and blue light (B). Each colored light will be composed by red light, green light, and blue light with different ratio. In the following paragraphs, the signal R expresses red data, the signal G expresses green data, and the signal B expresses blue data of each colored light, which is composed by red light, green light, and blue light with different ratio.

In the scanning procedure, the photoelectric module gets R, G, and B of each pixel, which is on a line of a waited scanning image and will produces a corresponding analogy signal. The analogy signal will be transmitted to the analog-digital converter to generate a digital date to be dealt with by using the next device. Then the photoelectric module gets R, G, and B of each pixel, which is on next line, and proceeds the similar steps of the above statement. The scanning procedure will divide into two types, such as the one-channel scanning procedure and the three-channel scanning procedure, according to different scanning method and different data processing method.

Referring to FIGS. 1A and 1B, this shows a diagram in an image, which is got from the traditional technology and is before transmitted. FIG. 1A shows how to choose the scanning beginning position and scanning area of R, G, and B. In FIG. 1A, each block expresses one color information of a pixel in a the waited scanning area. The number, which is in the block, expresses the location of the pixel in the waited scanning area. In the specification of the present invention, the signal P(x, y) expresses the image information-pixel value, wherein the signal x expresses a serial number of lines and the signal y expresses a serial number of the pixel on a line. For example, the signal P(2n−1, 1) expresses a pixel value, which is the first pixel of the 2n−1 line, wherein the signal n is a natural number.

In the traditional technology, the scanning beginning position of R, G, and B is on the first pixel of the waited scanning area when the 2n−1 line is scanned. The scanning area is a complete scanning area and the DPI of the image is complete.

FIG. 1B shows a condition of R, G, and B, which corresponds to each pixel. In FIG. 1B, the signals R(x, y), G(x, y), and B(x, y) individually express the colored information of the pixel P(x, y). If each pixel of R, G, and B is expressed in 8 bits, the data amount of each pixel is 3*8=24 bits.

From FIG. 1A and FIG. 1B, when the traditional scanner transmits the image data to the personal computer, all of R, G, and B of each pixel are transmitted. The image data, which will be transmitted, will be saved in a buffer of the scanner at first. When the buffer is full or the buffer gets a scanning suspending signal, the buffer will transmit the data, which are saved in it, to the server to be dealt with. In general, occupied memory space of pixels is very huge. Therefore, if all of the R, G, and B of each pixel are saved in the buffer without compression procedure, the buffer will be often full and will transmit its inside saved data to the server frequently. When the amount of image data is greater, the buffer full conditions are more and times of the transmitting data are following increased. Therefore, the scanning velocity of the scanner will be decreased and the life-time of the buffer will be decreased.

A bottleneck of a velocity of the traditional scanning device is usually happened in transmitting data from the scanning device to the server. Because the amount of the image data is over great, the image data must be transmitted to the server in turn. This condition will decrease the scanning velocity. Therefore, in order to increase the scanning velocity, it is a good method to decrease the amount of image data, which are transmitted form the scanning device to the server.

### SUMMARY OF THE INVENTION

In accordance with the background of the above-mentioned invention, the traditional transmission method will increase the times of the transmissions and will decrease the scanning velocity because of over amount of the image data. The present invention provides a method to decrease the amount of the transmission data by using the compression method in real time to pre-compress the image date before they are transmitted to the server.

The second objective of the present invention is to decrease the times of transmission the image data from the buffer to the server by using the compression method in real time to pre-compress the image date before they are transmitted to the server.

The third objective of the present invention is to increase the scanning velocity by using the compression method in real time to pre-compress the image date before they are transmitted to the server.

The fourth objective of the present invention is to decrease the times of the buffer full by using the compression method in real time to pre-compress the image date before they are transmitted to the server.

The further objective of the present invention is to extend the life time of the buffer by using the compression method in real time to pre-compress the image date before they are transmitted to the server.

In according to the foregoing objectives, the present invention provides a method for pre-compressing the image date before they are transmitted to the server by using the compression method in real time to decrease the amount of the image data. At first, the present invention divides an image, which is got after a pre-scanning process, into plural lines. Each line is divide into several blocks, whose sizes are the same. Each block comprises plural pixel values. A pixel value of a block is saved in the buffer completely to become the first datum. The pixel value is usually the minimum pixel value. Then plural differences, which are between the first datum and the plural pixel values of the block, are calculated. One of the plural differences, which are not equal to zero, is saved in the buffer completely to become the second datum. The difference, which is not equal to zero, is usually a minimum difference. Using the second datum to be a divisor and using the plural differences to be dividends will get plural specific values of plural differences to the second datum. When the first number, which is after a dot, of the specific value is greater than a fixed value or equal to the fixed value, it will be carried to the first number, which is in front of the dot and numbers, which are after the dot, are deleted. When the first number, which is after a dot, of the specific value is lower than a fixed value, numbers, which are after the dot, are deleted. This method will make the specific values become integers. At last, the plural specific values are saved in the buffer completely to become the plural third data and the compression procedure of the block is finished. Then the next block is compressed by the same procedure to decrease the amount of the image data completely and to decrease the times of transmission the image data from the buffer to the server. The present invention can also decrease the times of the buffer full and extend the life time of the buffer. The present invention can further increase the scanning velocity of the scanner.

### BRIEF DESCRIPTION OF THE DRAWINGS

In the accompanying drawing forming a material part of this description, there is shown:

FIG. 1A shows a diagram in how to choose the scanning beginning position and scanning area of R, G, and B;

FIG. 1B shows a diagram of R, G, and B, which corresponds to each pixel;

FIG. 2 shows a diagram in dividing the image data, which is got from the pre-scanning procedure, into plural blocks;

FIG. 3 shows a diagram in an arrangement of each pixel datum in each block; and

FIG. 4 shows a flowchart in compressing image data in real time of the present invention.

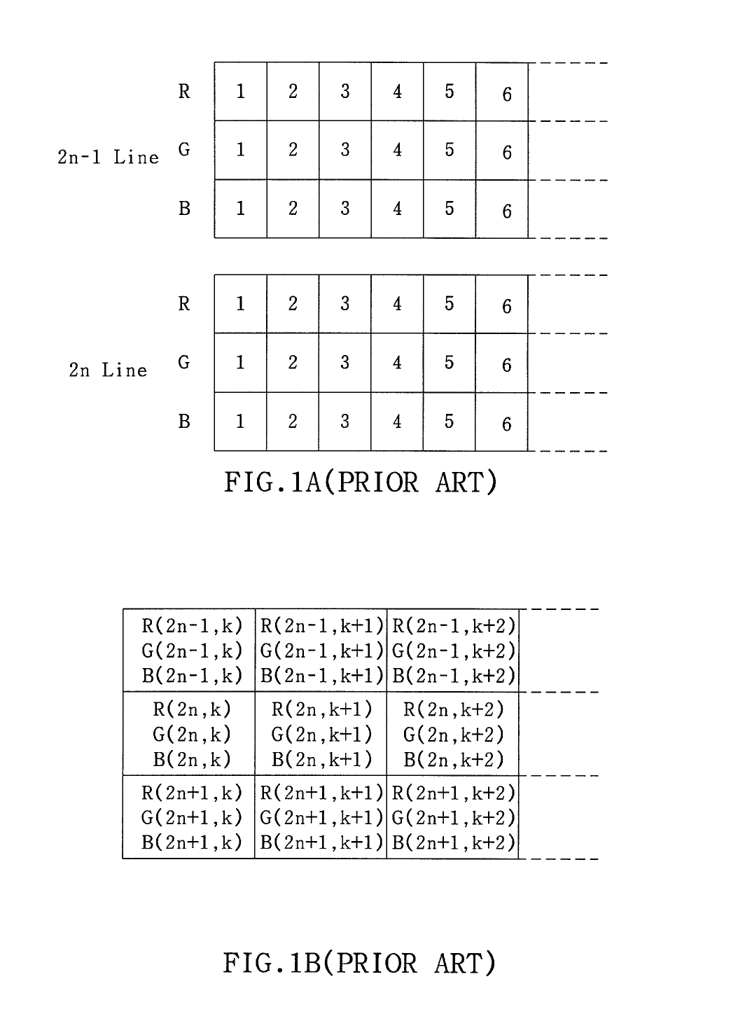

### DESCRIPTION OF THE PREFERRED EMBODIMENT

The foregoing aspects and many of the intended advantages of this invention will become more readily appreciated as the same becomes better understood by reference to the following detailed description, when taken in conjunction with the accompanying drawings, wherein:

The present invention provides a method for pre-compressing the image date before they are transmitted to the server by using the compression method in real time to decrease the mount of the image data. At first, the present invention divides an image, which is got after a pre-scanning process by using a charge-coupled device CCD, into plural lines. The plural lines are composed with a line, which is got by using the charge-coupled device. Because a plane is composed with a lot of lines, the charge-coupled device just save a scanned paper, which has been divided into plural lines, in the scanning procedure. At last the plural lines will be transmitted to the server and will be composed to become the paper on the server. The information type of the line is usually the data of a line.

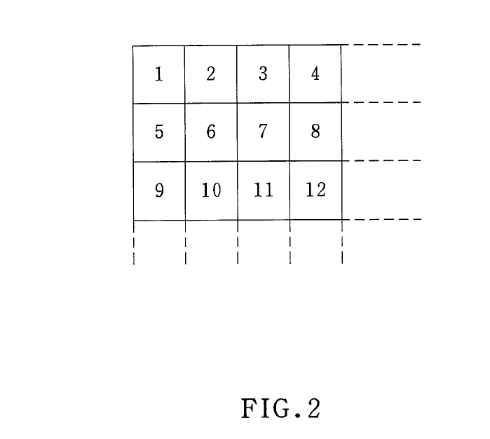

Then Each line is divide into several blocks, whose sizes are the same (referring to FIG. 2). An amount of blocks on each line is set in fixed value. Following different needs of products, the amount of the blocks on each line will be adjusted following different image data to increase the velocity of the image data processing. Each block comprises plural pixel values. In usual, an amount of pixels in each block is the same. Following different needs of products, the amount of the pixels in each block will be adjusted following different image data to increase the velocity of the image data processing.

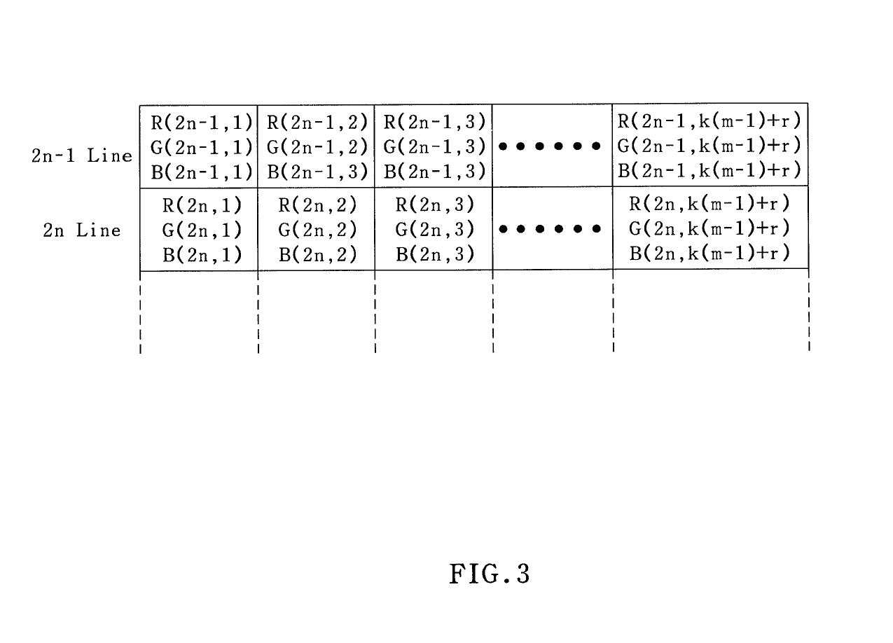

Referring to FIG. 3, this shows a diagram in an arrangement of each pixel datum in each block but the diagram can not limit the scope of the present invention. The signal P(x, y) expresses the image information-pixel value, wherein the signal x expresses a serial number of lines and the signal y expresses a serial number of the pixel on a line. For example, the signal P(2n−1, 1) expresses a pixel value, which is the first pixel of the 2n−1 line, wherein the signal n is a natural number. The signals R(x, y), G(x, y), and B(x, y) individually express the colored information of the pixel P(x, y). Following setting different sizes of the blocks, the arrangement of each block is different. If a memory capacity of the first block is set to have k pixels and others blocks are set to have k pixels, wherein the signal k expresses a natural number, a serial number of each pixel in each block on the same line is P(2n−1, (k(m−1)+r)), wherein the signal m expresses the serial number of the block on the line and the signal r expresses the serial number of the pixel in the block.

After dividing the image data into the plural blocks, one of the plural blocks is chosen to proceed the image data compression procedure. At first the plural pixel values of the plural pixel are compared and one of the plural values will be saved in the buffer completely to become the first datum. The pixel value is usually a minimum pixel value of the block. Then plural differences, which are between the first datum and the plural pixel values of the block, are calculated. One of the plural differences, which are not equal to zero, is saved in the buffer completely to become the second datum. The difference, which is not equal to zero, is usually a minimum difference.

After saving the second datum in the buffer completely, the second datum is used to be a divisor and the plural differences is used to be dividends to get plural specific values of plural differences to the second datum. The plural specific values are saved in the buffer separately to become plural third data and the compression procedure of the block is finished. Then the next block will be compressed by using the compression procedure of the present invention. When each block of the image data is compressed completely by using the method of the present invention, the immediate compression procedure of the present invention is finished. The plural third data stand for the plural pixel values of the plural pixels in the block. Therefore, using the method of the present invention will compress each pixel of the image data completely to increase the scanning efficiency of the scanner. In usual, each of the plural third data will be saved in the buffer in six bits of memory mode. Following the needs of the products and differences of the image data, the memory mode is different.

Because the second datum is the number, which is not equal to zero, the infinity value will not be brought in the calculating the plural specific value procedure when the second datum is used to be the divisor. When the plural specific values are calculated, the plural differences and the second datum are not always in an integer relation. Therefore, after calculating the plural specific values, the partial plural specific values have decimals. In order to make all plural specific values to become the integers, a fixed value will be set in the buffer to make all plural specific values to become the integers and to benefit the following saving the plural specific values in the buffer procedure. When the first number, which is after a dot, of the specific value is greater than a fixed value or equal to the fixed value, it will be carried to the first number, which is in front of the dot and numbers, which are after the dot, are deleted. When the first number, which is after a dot, of the specific value is lower than a fixed value, numbers, which are after the dot, are deleted. This method will make the specific values become integers. In usual, the fixed value is “5”.

When the buffer is full or the image data compression procedure is finished, the data, which are saved in the buffer, will be transmitted to the server to be composed to become the image and the scanning procedure is finished. Using the immediate compression procedure of the present invention will make the buffer save more data of the pixels. When the buffer is full or the image data compression procedure is finished, the data, which are saved in the buffer, will be transmitted to the server to proceed the composite procedure. Therefore, the times of the buffer full will be decreased and the times of transmitting the data from the buffer to the server will be decreased. The life time of the buffer will also be extended and the scanning velocity of the scanner will also be increased.

The following statement is a embodiment of the immediate compression procedure of the present invention. The embodiment will not limit the scope of the present invention. At first, an image datum is divided into the first line, the second line, and the third line. The first line comprises the first block, the second block, and the third block. The second line comprises the fourth block, the fifth block, and the sixth block. The third line comprises the seventh block, the eighth block, and the ninth block. The size of each block, which comprises six different pixel values of the six pixels, is the same. At first, data, which are in the first block, are compared, wherein the first block comprises the first pixel, the second pixel, the third pixel, the fourth pixel, the fifth pixel, and the sixth pixel. The first pixel is next to the second pixel. The second pixel is next to the first pixel and the third pixel and is between the first pixel and the third pixel. The third pixel is next to the second pixel and the fourth pixel and is between the second pixel and the fourth pixel. The fourth pixel is next to the third pixel and the fifth pixel and is between the third pixel and the fifth pixel. The fifth pixel is next to the fourth pixel and the sixth pixel and is between the fourth pixel and the sixth pixel. The sixth pixel is next to the fifth pixel. When the pixel value of the second pixel is a minimum pixel value of the first block, the pixel value of the second pixel is saved in the buffer completely to become the first datum. Then the first difference, which is between the first datum and the pixel value of the first pixel, the second difference, which is between the first datum and the pixel value of the second pixel, the third difference, which is between the first datum and the pixel value of the third pixel, the fourth difference, which is between the first datum and the pixel value of the fourth pixel, the fifth difference, which is between the first datum and the pixel value of the fifth pixel, and the sixth difference, which is between the first datum and the pixel value of the sixth pixel are calculated to get a minimum difference, which is not equal to zero. Although the second difference is the minimum difference. The second difference is equal to zero and can not be chosen to cooperate the following steps. After judging the third difference is the minimum difference and is not equal to zero, the third difference will be saved in the buffer completely to become the second datum. Then the second datum is used to be a divisor and each of the differences is used to be dividends to calculate the first specific value of the first difference to the second datum, the second specific value of the second difference to the second datum, the third specific value of the third difference to the second datum, the fourth specific value of the fourth difference to the second datum, the fifth specific value of the fifth difference to the second datum, and the sixth specific value of the sixth difference to the second datum. When each specific value has decimals, the first number, which is after the dot, will be judged that it is greater than or equal to a fixed value or not. When the first number, which is after a dot, of the specific value is greater than a fixed value or equal to the fixed value, it will be carried to the first number, which is in front of the dot and numbers, which are after the dot, are deleted. When the first number, which is after a dot, of the specific value is lower than a fixed value, numbers, which are after the dot, are deleted. This method will make the specific values become integers. Then the first specific value, the second specific value, the third specific value, the fourth specific value, the fifth specific value, and the sixth specific value are saved in the buffer and the compression procedure of the first block is finished. Then the second block, the third block, the fourth block, the fifth block, the sixth block, the seventh block, the eighth block, and the ninth block will be compressed by using the same compression procedure. At last, data, which are saved in the buffer, are transmitted to the server to be composed to an image.

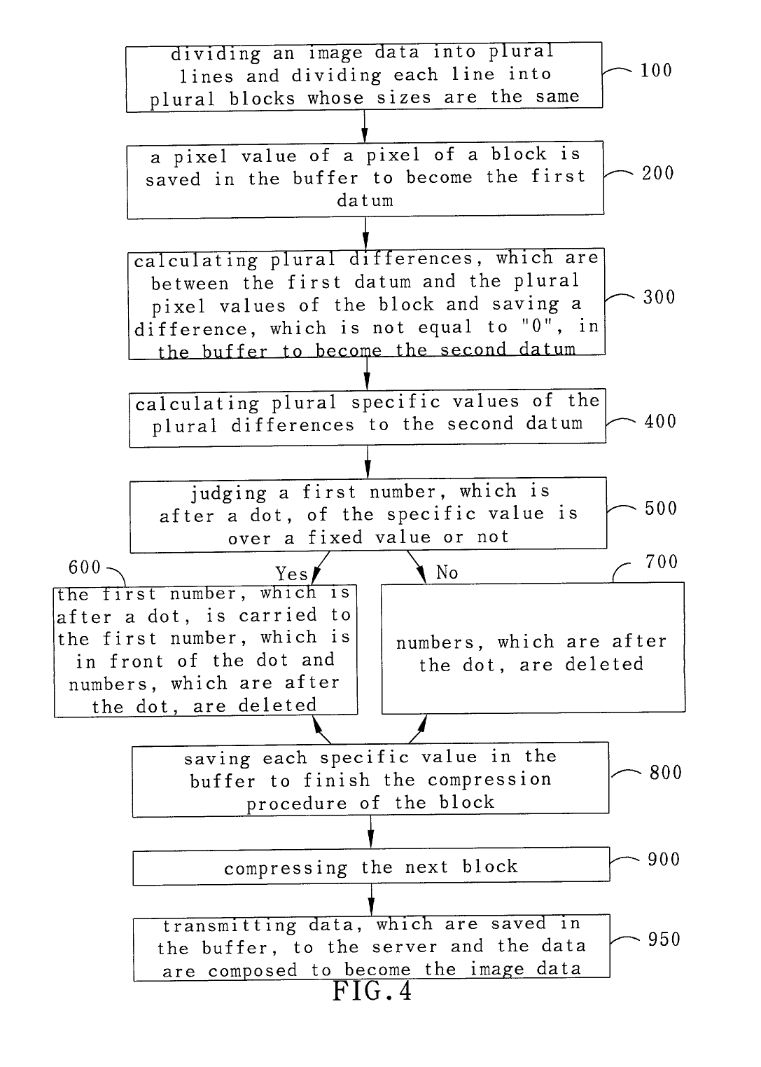

Referring to FIG. 4, this shows a flowchart in compressing image data in real time of the present invention. At first, the present invention divides an image, which is got after a pre-scanning process, into plural lines. Each line is divide into several blocks, whose sizes are the same. Each block comprises plural pixel values 100. A pixel value of a block is saved in the buffer completely to become the first datum 200. The pixel value is usually the minimum pixel value. Then plural differences, which are between the first datum and the plural pixel values of the block, are calculated. One of the plural differences, which are not equal to zero, is saved in the buffer completely to become the second datum 300. The difference, which is not equal to zero, is usually a minimum difference. Using the second datum to be a divisor and using the plural differences to be dividends will get plural specific values of the plural differences to the second datum 400. Judging a first number, which is after a dot, of the specific value is greater than or equal to a fixed value or not 500. When the first number, which is after a dot, of the specific value is greater than or equal to a fixed value, it will be carried to the first number, which is in front of the dot and numbers, which are after the dot, are deleted to make specific values become integers 600. When the first number, which is after a dot, of the specific value is lower than a fixed value, numbers, which are after the dot, are deleted to make specific values become integers 700. Then each specific value is saved in the buffer to become the third datum and the compression procedure of the block is finished 800. Then the next block is compressed by using the same compression procedure 900. After compressing all blocks, data, which are saved in the buffer, are transmitted to the server to be composed to become the image 950.

In accordance with the present invention, the present invention provides a method for pre-compressing the image date before they are transmitted to the server by using the compression method in real time to decrease the amount of the image data. At first, the present invention divides an image, which is got after a pre-scanning process, into plural lines. Each line is divide into several blocks, whose sizes are the same. Each block comprises plural pixel values. A pixel value of a block is saved in the buffer completely to become the first datum. The pixel value is usually the minimum pixel value. Then plural differences, which are between the first datum and the plural pixel values of the block, are calculated. One of the plural differences, which are not equal to zero, is saved in the buffer completely to become the second datum. The difference, which is not equal to zero, is usually a minimum difference. Using the second datum to be a divisor and using the plural differences to be dividends will get plural specific values of plural differences to the second datum. When the first number, which is after a dot, of the specific value is greater than or equal to a fixed value, it will be carried to the first number, which is in front of the dot and numbers, which are after the dot, are deleted. When the first number, which is after a dot, of the specific value is lower than a fixed value, numbers, which are after the dot, are deleted. This method will make the specific values become integers. At last, the plural specific values are saved in the buffer completely to become the plural third data and the compression procedure of the block is finished. Then the next block is compressed by the same procedure to decrease the amount of the image data completely and to decrease the times of transmission the image data from the buffer to the server. The present invention can also decrease the times of the buffer full and extend the life time of the buffer. The present invention can further increase the scanning velocity of the scanner.

Although specific embodiments have been illustrated and described, it will be obvious to those skilled in the art that various modifications may be made without departing from what is intended to be limited solely by the appended claims.

What is claimed is:

1. A method for compressing an image in real time, said method comprises:
dividing said image into plural lines, wherein each of said plural lines comprises plural blocks and each of said plural blocks comprises plural pixels;
proceeding a line compression procedure to compress each of said plural lines, wherein said line compression procedure comprises:
proceeding a block compression procedure to compress each of said plural blocks, wherein said block compression procedure comprises:
saving a first datum in a memory, wherein said first datum is a pixel value of a pixel in a block by using a first judging procedure;
calculating plural differences between the first datum and plural pixel values of said plural pixels;
saving a second datum in said buffer, wherein said second datum is a difference of said plural differences by using a second judging procedure and said difference is not equal to zero;
calculating plural specific values of said plural differences to said second datum, wherein said plural specific values pass through an adjusting procedure to become integers;
saving said plural specific values in said memory;
saving the plural third data of said plural blocks;
saving the plural fourth data of said plural lines; and
composing said plural fourth data to become said image.

2. The method according to claim 1, wherein said pixel value is a minimum pixel value of said plural pixel values.

3. The method according to claim 1, wherein said memory is a buffer.

4. The method according to claim 1, wherein said first judging procedure is to compare values of said plural pixel values.

5. The method according to claim 1, wherein said difference is a minimum difference of said plural differences.

6. The method according to claim 1, wherein said second judging procedure is to compare values of said plural differences

7. The method according to claim 1, wherein said adjusting procedure comprises:
carrying from a first number, which is after a dot, to a first number, which is in front of said dot, of said plural specific values and deleting numbers, which are after said dot, when said first number, which is after said dot, of said plural specific values is greater than or equal to a fixed value; and
deleting said numbers, which are after said dot, when said first number, which is after said dot, of said plural specific values is lower than said fixed value.

8. The method according to claim 7, wherein said fixed value is “5”.

9. The method according to claim 1, wherein said plural specific values are saved in said memory in six bits mode.

10. A method for compressing an image in real time, said method comprises:
dividing said image into plural lines, wherein each of said plural lines comprises plural blocks and each of said plural blocks comprises plural pixels;
proceeding a line compression procedure to compress each of said plural lines, wherein said line compression procedure comprises:
proceeding a block compression procedure to compress each of said plural blocks, wherein said block compression procedure comprises:
saving a first datum in a memory, wherein said first datum is a minimum pixel value of a pixel in a block;
calculating plural differences between the first datum and plural pixel values of said plural pixels;
saving a second datum in said buffer, wherein said second datum is a minimum difference of said plural differences and said minimum difference is not equal to zero;
calculating plural specific values of said plural differences to said second datum,
carrying from a first number, which is after a dot, to a first number, which is in front of said dot, of said plural specific values and deleting numbers, which are after said dot, when said first number, which is after said dot, of said plural specific values is greater than or equal to a fixed value;
deleting said numbers, which are after said dot, when said first number, which is after said dot, of said plural specific values is lower than said fixed value;
saving said plural specific values in said memory;
saving the plural third data of said plural blocks;
saving the plural fourth data of said plural lines; and
composing said plural fourth data to become said image.

11. The method according to claim 10, wherein said memory is a buffer.

12. The method according to claim 10, wherein said fixed value is “5”.

13. The method according to claim 10, wherein said plural specific values are saved in said memory in six bits mode.
